(19) United States
(12) Patent Application Publication
(10) Pub. No.: US 2019/0276906 A1
(43) Pub. Date: Sep. 12, 2019

(54) HIGH HEAT FLUX REGIME COOLERS

(71) Applicant: MacRae Technologies, Inc., Hayward, CA (US)

(72) Inventor: Allan J. MacRae, Hayward, CA (US)

(21) Appl. No.: 16/422,909

(22) Filed: May 24, 2019

Related U.S. Application Data
(63) Continuation-in-part of application No. 16/290,922, filed on Mar. 3, 2019.
Application No. 16/290,922 is a continuation-in-part of application No. 16/101,418, filed on Aug. 11, 2018, now Pat. No. 10,364,475.
Application No. 16/101,418 is a division of application No. 15/815,343, filed on Nov. 16, 2017, now Pat. No. 9,963,754.
Application No. 15/815,343 is a continuation-in-part of application No. 13/147,996, filed on Dec. 23, 2011.
Application No. 13/147,996 is a continuation-in-part of application No. 13/148,003, filed on Dec. 23, 2011, now Pat. No. 10,247,477.
(60) Provisional application No. 62/808,857, filed on Feb. 22, 2019.
(60) Provisional application No. 62/701,832, filed on Jul. 22, 2018.

(51) Int. Cl. C21B 7/10; F27D 1/00; F28D 1/06; F27B 1/14; F28F 21/08

(52) U.S. Cl. CPC C21B 7/10; F27D 1/004; C21C 5/4646; F27B 1/14; F28F 21/082; F28D 1/06

(57) ABSTRACT

High heat flux furnace cooler comprise CuNi pipe coils cast inside pours of high purity (99%-Wt) copper. The depth of front copper cover over the pipe coils in the hot face to manufacture into the casting is derived from a projection of the thermal and stress conditions existing at the cooler's end-of-campaign-life. CFD and/or FEA analyses and modeling is used for a trial-and-error zeroing in of the optimum geometries to employ in the original casting of CuNi pipe coils in high purity copper casting. Individual pipe coil positions to cast inside a copper casting mold are secured with devices that will not melt, cause thermal shear stresses, or be the source of contaminations or copper defects. Pipe bonding to the casting results because the differential coefficient of expansions of the pipes' and the casting's copper alloys involved do not exceed the yield strength of the casting copper during operational thermal cycling.

### BACKGROUND

### 1. Field of the Invention

The present invention relates to copper coolers used in the walls and roof of furnace crucibles, and more particularly to the design, casting, and computer modelling of thermal and shear stresses in coolers placed in service with average heat loads exceeding 25 kW/m².

### 2. Description of the Prior Art

The heat removal characteristics of coolers can be estimated using finite element analysis (FEA) computer modelling. FEA alone cannot account for chemical corrosion and mechanical erosion aspects at a so-called “hot face”. However, FEA can be used to estimate a temperature distribution within a casting, as well as for any material in front of the cooler, i.e., for specified constant surface temperature, applied heat flux, and other boundary conditions. Mechanical stresses are then calculable from the thermal results.

Computational fluid dynamics (CFD) is used to model fluid flows, pressures, chemical reactions, and heat transfer. CFD is based on the Navier-Stokes equations which are derived from Newton's second law. The equations can be solved directly if flow in the system is laminar. However, flows in practical applications are often turbulent. With turbulent flows, several different turbulence models can be used to solve the equations. However, they all have advantages and disadvantages when compared to other turbulence models. The turbulence models can be divided in two types: to Reynolds averaged Navier-Stokes models (RANS) and direct numerical simulations (DNS).

The high temperatures used in metallurgical furnaces are severe enough to erode the brick-linings of crucibles. Refractory materials are conventionally used to line the insides of crucibles, and the prior art has adopted the use of coolers behind such linings to reduce wear, and/or to develop a near stable residual lining thickness often referred to as freeze-lining. The operational result is a thin protective layer frozen from the molten slag, matte and/or metal splashing on the walls. The accretions helps stabilize against break-out and heat losses.

Typical coolers are formed as burner coolers, launders, tuyeres, staves, wall coolers, roof coolers, transition coolers, casting molds, electrode clamps, tap-hole coolers, and hearth anodes. Most modern pyro-metallurgical furnaces use some kind of cooling system to stabilize the relentless erosion of wall, roof and hearth refractories.

Coolers are arranged in a variety of ways in the walls, roofs and hearths of cylindrical furnaces, oval furnaces, blast furnaces, Mitsubishi-style flash smelting and converting furnaces, IsaSmelt furnaces, Ausmelt furnaces, fuming furnaces, electric arc furnaces (EAF), both AC and DC, basic oxygen furnaces (BOF), electric slag cleaning furnaces, rectangular furnaces, Outokumpu flash smelting and converting furnaces, Inco flash smelting furnaces, slag cleaning furnaces, and reverbatory furnaces. Coolers can very easily be stacked vertically, horizontally, or tilted in layers, with alternating courses of refractory.

A wear resisting barrier of metal, refractory brick and/or castable refractory is sometimes used as a lining on the hot face of a cooler. Such hot faces can be smooth, or can include pins, deep pockets and/or grooves that are machined on after or cast-in before.

A serious problem develops when the cooling pipes to be embedded and the metal castings they are embedded in are two different materials. Different materials have different coefficients of thermal expansion. If the differences are large, sufficient bonding between the pipe coils and castings will be stymied during the heating and cooling of the casting process. Or the strength of the bonding afterward between the pipe coils and the castings will be inadequate to survive the service they must perform.

Frequent thermal cycling can work the pipe loose of the casting over the service life. The thermal efficiency drops significantly where ever the pipe-casting bonds fail.

However, pipes made of materials with melting points that are just a bit higher than the molten casting metal are a salvation because the pipe coils made of such materials resist softening and break-through during the casting pour.

A conventional work-around for the problem has been to tightly stuff the pipe coils with sand so they will be shored up against collapse if the pipe coils soften by the heat too much. Such sand is always washed out after the casting has cooled.

Some combinations of cooling pipe and metal casting materials are known in the prior art as being able to provide at least an acceptable service life.

Monel-400 pipes have been cast in copper coolers for many years. (Monel-400 is a trademark brand for an alloy of about 63% nickel and 31% copper.) Unfortunately, published failure analyses have shown that the copper coolers were never bonded or in complete contact with the Monel-400 pipe when they left the copper mold. Many defects are seen in testing and evaluation of the Monel-to-copper casting bond. The bonding defects found were sufficient to reduce the thermal transfer efficiency and introduce significant unknowns for modelling for the overall furnace-cooling patterns.

Prior art copper cooler designs were manufactured from copper billets drilled with longitudinal holes for water passages. Extruded holes have also been used for the water passages, but some of these have been well-known failures. Transverse drill holes with internal plugs have also been tried in forming internal cooling-water circuits. The drilled and extruded designs normally include plugs to be installed in all the open drill ends around the edges of the billet coolers.

Solder, welded, and pipe-thread type plugs have all been tried. But many such coolers leak nonetheless, and such leaks are very dangerous in a metallurgical furnace. The size and shape of such kinds of coolers is limited by the ability to cast or forge the copper billets.

The internal water passage layout is often very constrained by having to build up the water passages from combinations of interconnected drill bores. In contrast, cast coolers can be made in a wide variety of cooler shapes and sizes, and almost any layout is possible with the internal piping. Cast copper coolers can normally be used with much larger heat loads, compared to drilled and plugged coolers.

The fabrication of drilled coolers and cast coolers each present their own sets of challenges. In casting, the water pipes can be advantageously tested for flow and pressure before and after casting. The danger of a leak through a copper cooler with fabrication voids is very low because the pipe walls will contain the water.

Conventional cast coolers are typically manufactured by forming a water pipe into a desired layout and pressure-testing it, before and after, to 150% or more of the design operating water pressure for at least fifteen minutes. Before each casting pour, the outside of the pipe is cleaned to minimize any gas bubble formation that can result in porous casting sections at the pipe-coil and cast-copper interfaces.

Sand is sometimes packed in to fill the inside of the pipe coils and shore up the walls against sagging, but only when using a pipe coil material with a melting point higher than the casting temperature of copper. For example, Monel-400 pipe does not ordinarily need to be packed with sand before casting. The casting molds are made with extra allowances for later machining off of porous sections, gates, risers, and shrinkage. Such molds are typically made from sand that has been mixed with a bonding agent.

The original model shapes are made from wood and other easily formed materials before being pressed in the sand. The pipe coils are securely placed inside the sand mold into the exact positions that were calculated and modeled by CFD and FEA to be optimum. But very few, if any, go the bother of CFD and FEA for both thermal and stress analyses because of the expense of modelling time and software.

Conventional coolers can range in weight from as little as one hundred pounds to as much as several tons, depending on the furnace application. What is needed is a high heat flux cooler that can be made from readily obtainable and relatively inexpensive commercial materials, and yet achieves strong fusion between the piping and the casting. The differential coefficient of expansion must also be such that high heat flux and constant thermal cycling can be tolerated over the operational lifetime without cracking or other materials failures.

In a previous invention of mine that was well received, a furnace-cooling block comprised a UNS C70600 90%, C71300 75%, C71500 70%, C71640 66%, or UNS C70600 Schedule-40 water pipe cast inside a pour of high purity (99%-Wt) copper UNS-type C11000 de-oxidized during the casting process to produce a high-purity copper approximating UNS-type C81100. A resulting fusion of the pipe to the casting was such that the differential coefficient of expansions of the two copper alloys involved did not exceed the yield strength of the casting copper anticipated during operational thermal cycling in service. The melting point of the copper alloy I used in the pipe was such that a relatively thin-wall pipe could be used with a sand packing during the melt.

Various tests conducted found that the grains of the cast copper had metallurgically bonded to the pipe coils' UNS C70600 90%, C71300 75%, C71500 70%, C71640 66%, or UNS C70600 copper-nickel alloy pipe. Such fusions kept the pipe from separating from the cast copper. Such a good metallurgical bond was not normally observed in any prior art coil materials, i.e., copper pipe, Monel-400 pipe, etc.

### SUMMARY OF THE INVENTION

Briefly, a high heat flux furnace cooler embodiment of the present invention comprises a CuNi pipe coil cast inside a pour of high purity (99%-Wt) copper de-oxidized during the casting process, or that was melted in an inert environment. The depth and position relative to a hot face that the pipe coil must finish at is derived from iterative computational fluid dynamics (CFD) and/or finite element analysis (FEA) analyses and modelling. The finished position of the pipe coil is then fixed inside a copper casting mold by a sacrificial scaffolding of supports, spacers, wire ties and other devices each all a copper, a stainless steel, or a nickel alloy comprising at least 20%-Wt copper, or copper alloy and at least 10%-Wt nickel. A resulting fusion of the pipe coil to the casting is such that the differential coefficient of expansions of the two copper alloys involved does not ever exceed the yield strength of the casting copper during operational thermal cycling.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a functional block diagram of a high heat flux pyrometallurgical furnace for the production of at least one of molten metal, metal alloy, matte, or slag, and that comprises high heat flux coolers alternatively and dimensionally formed and finished in a shape suitable for service as a launder, a runner, a cooler, a wall cooler, a roof cooler, a burner block, a tuyere, a casting mold, an electrode clamp, a tap block cooler/insert, or a stave cooler. The pipe coils are diagramed as being disposed inside each high heat flux cooler relative to any surface and at a depth and a position derived from an intelligence results obtained for a particular design and a specific application of the high heat flux cooler using iterative computational fluid dynamics (CFD) and/or finite element analysis (FEA) analyses and modelling;

FIG. 2 is a functional block diagram of one of the coolers in FIG. 1, a hot face surface of the cooler faces a high level heat flux from the reactions occurring within the furnace crucible and every input to it;

FIG. 3 is a cross sectional diagram of a mold patterned to produce the coolers of FIGS. 1 and 2, the CuNi pipe coils of FIG. 4 are fully prepared for casting by welding of several copper-nickel, Monel-400, nickel, or stainless steel straps of FIGS. 5A-5C. It should be noticed in this case that the coolers' hot face faces down during casting;

FIG. 4A is a perspective view diagram, as seen from a hot face surface, of one arrangement of four independent CuNi pipe coils nested within others that work in tandem in a stave cooler embodiment. The CuNi pipe coils shown herein are prepared for casting, for example by welding on of several copper-nickel straps like in FIGS. 5A-5C;

FIG. 4B is a perspective view diagram, as seen from a hot face surface, of one arrangement of the four independent CuNi pipe coils of FIG. 4A nested within others that work in tandem in a stave cooler embodiment such as in FIGS. 6A-6D. The CuNi pipe coils shown herein fully prepared for casting, and are permanently attached by welding of several copper-nickel rods that bury their ends in the sand mold;

FIGS. 5A-5C are perspective view diagrams of one appliance that can be used as a casting chaplet. Using straps like these are not the best way to fixate the pipe coils in the casting mold because such straps can twist or warp in ways the pipe coils will move in the heat of the pour. Better devices are however proprietary to the leading foundries, and they employ trade secret rods, spacers, chaplets, and wires. The straps here can inhibit the pipe coils from cooperatively expanding and contracting with the casting as the molten copper pours in and wets the surfaces, bonds to the CuNi, and shrinks during cooling and solidification. Independent support of each pipe may be better;

FIG. 6A is an elevation view diagram of the backside of a stave cooler embodiment that stand up vertically in service and can measure ten feet tall, four feet wide, and two feet thick and is principally made of cast copper weighing 3,000 kg;

FIGS. 6B, 6C, 6D are cross sectional view diagrams of cross-sections A-A, B-B, C-C of the stave cooler of FIG. 6A;

FIG. 7 is a flowchart diagram of a method embodiment of the present invention for designing, computer modelling with CFD and FEA, casting, and foundry finishing coolers like those of FIGS. 1 and 2;

FIG. 8A is a perspective view diagram of a transition cooler embodiment as would be used in an Outokumpu or Inco Flash furnace, or any furnace with a gas offtake through the roof. A perspective view diagram of a pipe coil circuit-A is shown as a ghost inside the copper casting;

FIG. 8B is a perspective view diagram of a pipe coil circuit-B extracted from the transition cooler copper casting of FIG. 8A. Both pipe coil circuit-A and pipe coil circuit-B fit together inside the same transition cooler;

FIG. 8C is a perspective view diagram of pipe coil circuit-A and coil circuit-B nested together and from the cooler of FIGS. 8A and 8B with the transition cooler copper casting shown as ghost; and

FIG. 8D is a cross sectional view diagram of the transition cooler of FIGS. 8A-8C.

While the invention is open to various modifications and alternative forms, specifics thereof have been shown by way of example in the drawings and are described in detail. It should be understood, however, that the intention is not to limit the present invention to the particular embodiments described. On the contrary, this disclosure is intended to cover all foreseeable modifications, equivalents, and alternatives falling within the spirit and scope of the invention as defined by the appended claims.

### DETAILED DESCRIPTION OF THE PREFERRED EMBODIMENT

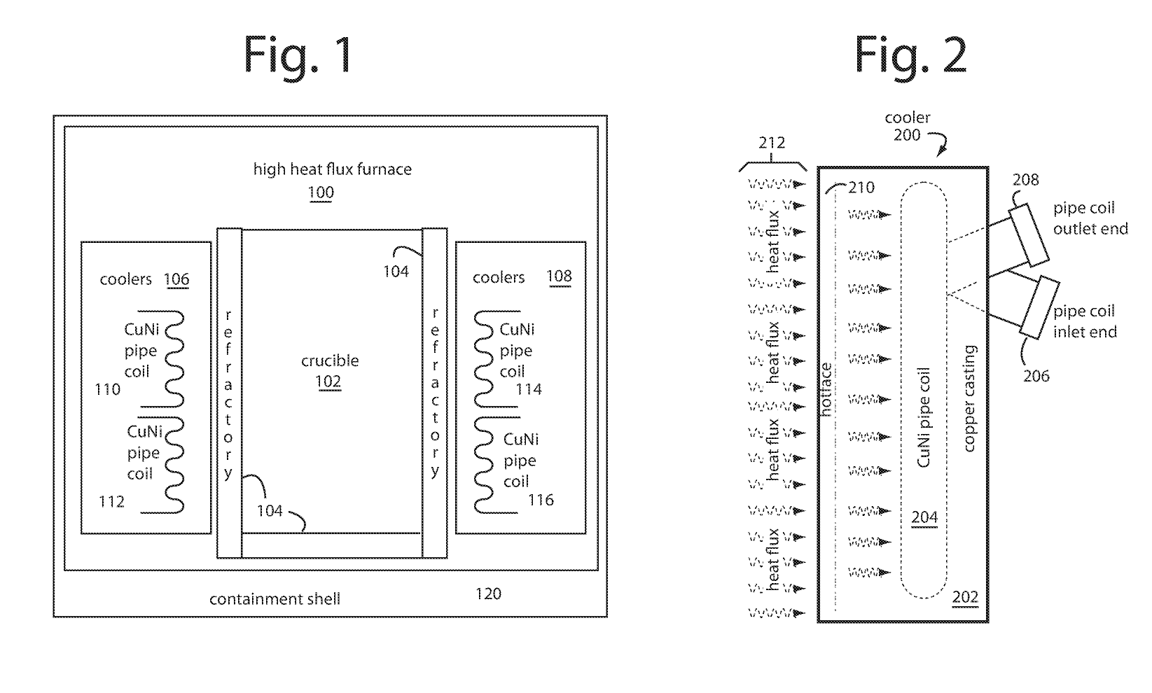

FIG. 1 represents a high heat flux pyrometallurgical furnace 100 comprising any furnace for the production of one or more of molten metal, metal alloy, matte, or slag. In particular, the types of furnaces and applications further may include plasma furnace, rotary holding, smelting, converting, or refining, direct reduced iron furnaces, furnaces with gas and/or concentrate injection such as a Vanyukov, tilting stations and granulators, gasifier roaster shaft furnace, etc.

Furnace 100 comprises a crucible 102 formed of refractory 104. These are, in turn, cooled by several high heat flux coolers 106, 108. These are each dimensionally formed and finished into a shape suitable for service as a launder, a runner, a cooler, a wall cooler, a roof cooler, a burner block, a tuyere, a casting mold, an electrode clamp, a tap cooler, off gas or fume hoods and ducts, feed and inspection ports, splash blocks, lintel coolers, or a stave cooler. The several high heat flux cooler coolers 106, 108 each comprise high purity (99%-Wt) copper castings in which CuNi pipe coils 110, 112, 114, and 116 are embedded during a pour of liquid copper into a mold. A steel containment shell 120 typically encloses furnace 100. In blast furnace applications for making pig iron, the steel containment shell 120 is gas-tight in order to prevent the uncontrolled escape of toxic process gases.

FIG. 2 represents a high heat flux cooler 200 in more detail than coolers 106, 108 in FIG. 1. High heat flux cooler 200 principally comprises a high purity (99%-Wt) copper casting 202. Inside casting 202 are positioned one or more CuNi pipe coils 204. These are supplied with coolant through one or more pipe coil inlet ends 206 and outlet ends 208, typically through heavy duty industrial hoses with pipe threads, brazed, or welded couplings. The high heat flux cooler 200 has at least one surface, i.e., a hot face 210, that faces and receives a high heat flux 212. The high heat flux cooler 200 absorbs and disposes of the high heat flux 212 that passes in and through hot face 210, casting 202, and CuNi pipe coils 204 into the coolant exhausted at outlet ends 208.

The portions of high purity (99%-Wt) copper casting 202 between hot face 210 and CuNi pipe coils 204 must be especially free of copper crystal defects and contaminates. The depth of CuNi pipe coils 204 inside casting 202 from hot face 210 must neither be too shallow nor too deep. If too deep, hot face 210 can melt under sudden increase or high heat flux 212. If too shallow, hot face 210 can heat unevenly sufficient to create ripples of stress that can crack the copper crystal or produce high shear stresses locally. This assumes the coolant flow and heat transport out are adequate.

The correct depth to set CuNi pipe coils 204 inside casting 202 from hot face 210 is determined from iterative computation fluid dynamics (CFD) and/or finite element analysis (FEA) computer modelling. Wherein, an estimate of what would be the correct depth is computer modeled in a first iteration, and then subsequent iterations are tried in trial-and-error to find the “correct” depth that strikes a best balance of many factors. Usually 2-4 iterations are sufficient.

Such CFD and FEA computer modelling requires specialized software, training, expertise, and an deep understanding of high heat flux coolers. It has therefore been conventional practice to base new designs only on previous designs that worked in a similar application. Such an engineering and manufacturing approach can have serious consequences. High heat flux applications are especially unforgiving and produce the most catastrophic and expensive consequences.

The intelligence obtained from iterative CFD and FEA computer modelling is then put to practical application in the casting of coolers 106, 108, 202.

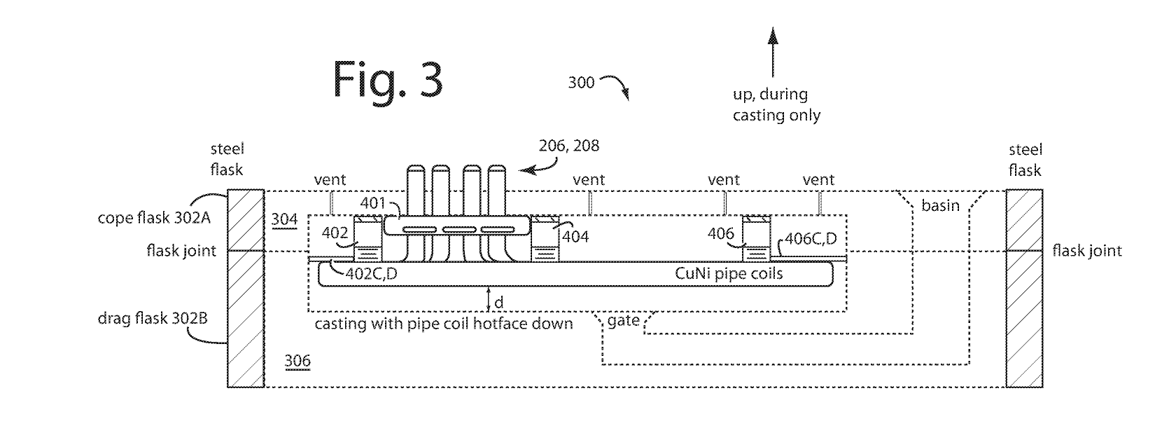

There are many undisclosed and trade secret methods and techniques in the US and elsewhere that could successfully cast CuNi pipe coils 204 inside casting 202 at a permanently fixed correct depth from hot face 210, FIG. 3 represents a possible, albeit not ideal approach.

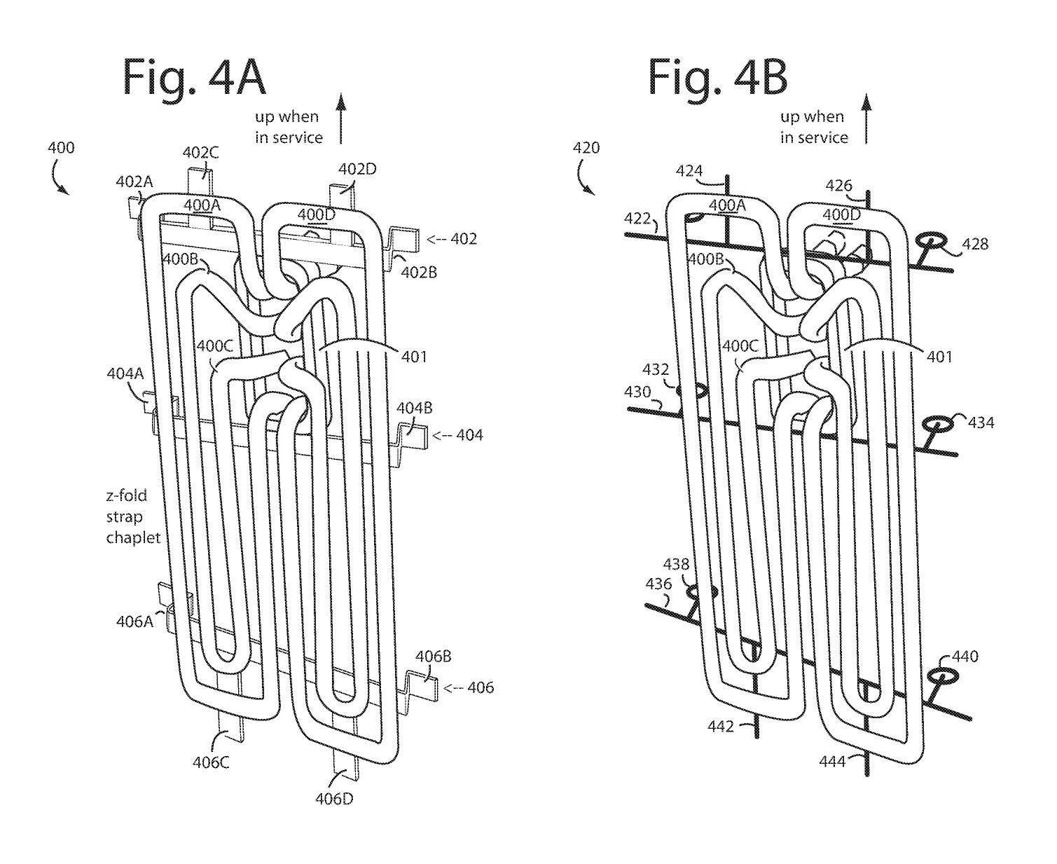

FIG. 3 exemplifies a copper casting method 300 that employs a steel flask cope 302A and drag 302B, each with both top and bottom openings. Steel cope flask 302A is placed over a first half of a 3D-pattern for a cooler 106, 108, 202. A cope mold 304 is formed by packing sand over a cooler pattern inside the steel flask 302. Steel drag flask 302B is placed over a second half of a 3D-pattern for a cooler 106, 108, 202. A drag mold 306 is formed by packing sand over the cooler pattern inside the steel drag flask 302B. The two 3D-patterns are removed and the CuNi pipe coils 400 of FIG. 4 are laid into cope mold 304. Cope mold 304 and drag mold 306 are joined together with CuNi pipe coils 400 inside. A copper cover (separation distance “d”) is critical, aka “front copper cover”. Typical coolers will have 0.35″ to 0.75″ copper cover on the back, and 1.10″ to 1.50″ on the front.

The CuNi pipe coil's 400 pipe inlet and outlet ends must be oriented facing up and protruding out the top through the cope mold 304. The drag mold 306 includes any deep surface patterning required in the hot face. For example, horizontal ribs and channels to retain refractory bricks, brick inserts, metal inserts, or pockets to retain shotcrete or other refractory or frozen slag.

Superheated liquid high purity (99%-Wt) copper is poured in through a basin 310 and that flows down a gate 312 to flood the interior from below. As the superheated liquid high purity (99%-Wt) copper floods in, the CuNi pipe coils 400 will try to float up in the z-direction and also try to shift in the x-y directions. The z-direction is up so any gases will escape through vents 314.

Any three-dimensional shifting of the CuNi pipe coils 400 inside the joined cope mold 304 and drag mold 306 is prevented by including casting chaplets, rods, spacers, wires, etc. The copper cover (separation distance “d”) is enforced by the casting chaplets.

In one embodiment, UNS C70600 90%, C71300 75%, C71500 70%, C71640 66%, or UNS C70600 copper-nickel alloy was used for the pipe coils. But before such is cast inside a cooling block, it must be cleaned thoroughly before the casting operation to ensure good fusion and bonding. Pure copper melts at about 1980° F., and copper ordinarily requires preheating when welding it. So it is advantageous to preheat the pipe coils just before they are cast inside a cooler, because this will drive off residual water.

ASTM Schedule-40 pipe, or thinner, can therefore be used for any UNS C70600 90%, C71300 75%, C71500 70%, C71640 66%, or UNS C70600 copper-nickel alloy pipe coils. And, tighter water passage spacing is made possible. The commercial cost UNS C70600 90%, C71300 75%, C71500 70%, C71640 66%, or UNS C70600 copper-nickel alloy pipe is less than Monel-400 pipe. The finished copper castings will run cooler, because of the higher thermal conductivity compared to Monel-400. Shear stresses at the interface of the CuNi alloy pipe to cast around copper is also less than with Monel-400 because of the better match in coefficients of expansion.

But, the lower melting point of UNS C70600 90%, C71300 75%, C71500 70%, C71640 66%, or UNS C70600 copper-nickel alloy, compared to that of Monel-400, means the preformed pipe coils of FIG. 4 should be packed internally with a mixture of sand and organic binders to stiffen and shore up the pipe coils from collapsing during the casting process.

If the pipe coils are not reinforced inside with sand, they may sag in sections that allow loops to bend closer to the hot face. (In the mold, the hot face is face down.) Such can render the cooler unusable.

After casting and cool down, the sand mix is knocked and vibrated loose.

In general, all embodiments of the present invention seek to strike a balance between the differential melting points, and the differential coefficients of expansion of the materials comprising the pipe coils and the copper casting. Large sufficient differential melting points means the pipe coil will not melt or soften during casting, and easily formed thin-wall pipes can be used with confidence.

And closer match of coefficients of expansion of the pipe and casting materials prevents the yield strengths of the materials from being exceeded later in service during operational thermal cycling.

Copper alloys are, in general, preferred for the pipe coils and casting materials because of their superior thermal conductivity compared to material costs. The respective copper-alloys used in the pipe and casting must be sufficiently different to result in maximal differential melting points, and sufficiently the same to result in a minimal differential coefficient of expansion.

Given these general constraints, the empirical solution found was to make cooler embodiments of the present invention with UNS C70600 90%, C71300 75%, C71500 70%, C71640 66%, or UNS C70600 copper-nickel alloy, and the final casting to UNS C81100 cast copper. The thermal conductivity of the copper predominates, and the yield strength at the fused interface are not over-stressed by operational thermal cycling. Other UNS-type alloy combinations could no doubt be satisfactory, but these will all necessarily need to meet the general constraints mentioned herein.

The material yield strengths of the pipe coils and castings both reduce proportionately as the copper content of the respective alloys increases. For example, the maximum copper casting stress at the pipe coil interface is almost linearly proportional from 8000 PSI if 30%-Wt copper to 2000 PSI if 100%-Wt copper. The maximum pipe stress is almost linearly proportional from 14000 35 PSI if 30%-Wt copper to 2000 PSI if 100%-W copper.

Pipe coils can be made of one piece of smooth-wall pipe bent to the desired shapes, or by welding in segments. If the required pattern is not practical, then pipe fittings are needed. The fittings must be welded-on, and any sharp edges should be ground smooth. Otherwise, the pipe joints will collect occlusions in the casting and/or generate voids.

Although UNS C70600 90%, C71300 75%, C71500 70%, C71640 66%, or UNS C70600 copper alloy is less likely to be contaminated by handling and storage than Monel-400, the same precautions and cleaning procedures conventional for Monel-400 are preferably used in making any embodiments of the present invention. For example, the pipe coils should not be handled with bare hands, and should be laid out on clean dry cardboard. Monel-400 tends to pick-up iron very easily. Iron and other contaminants left on the pipe during casting will convert to gases. After solidification, the gas bubbles lead to porosity in the finished copper casting.

Referring now briefly to FIG. 4, a set of CuNi pipe coils 400 is comprised of a set of four separate and independent CuNi pipe coils 400A, 400B, 400C, 400D. The number of coils varies with the design. All four separate and independent CuNi pipe coils 400A, 400B, 400C, 400D are supported before casting. Each CuNi pipe coil 400, must not shift of float inside cope mold 304 during casting.

The traditional way to support sand cores inside casting molds has been to use chaplets, rods, straps, wires, etc.

CuNi pipe coils 400A, 400B, 400C, 400D are positioned in proper relation to another, and the whole in proper relation to the inside of cope mold 304.

FIG. 4B represents an alternative to straps. A pipe coil 420 comprises the same independent CuNi pipe coils 400A, 400B, 400C, 400D of FIG. 4A. But they are connected together and prepared for casting with rods that are welded to their backsides. A top lateral rod 422 includes a top footer 424 and 426. A rod chaplet 428 does not penetrate the sand mold. A mid lateral rod 430 similarly has two rod chaplets 432 and 434. A bottom lateral rod 436 includes two rod chaplets 438 and 440 and a bottom footer 442 and 444.

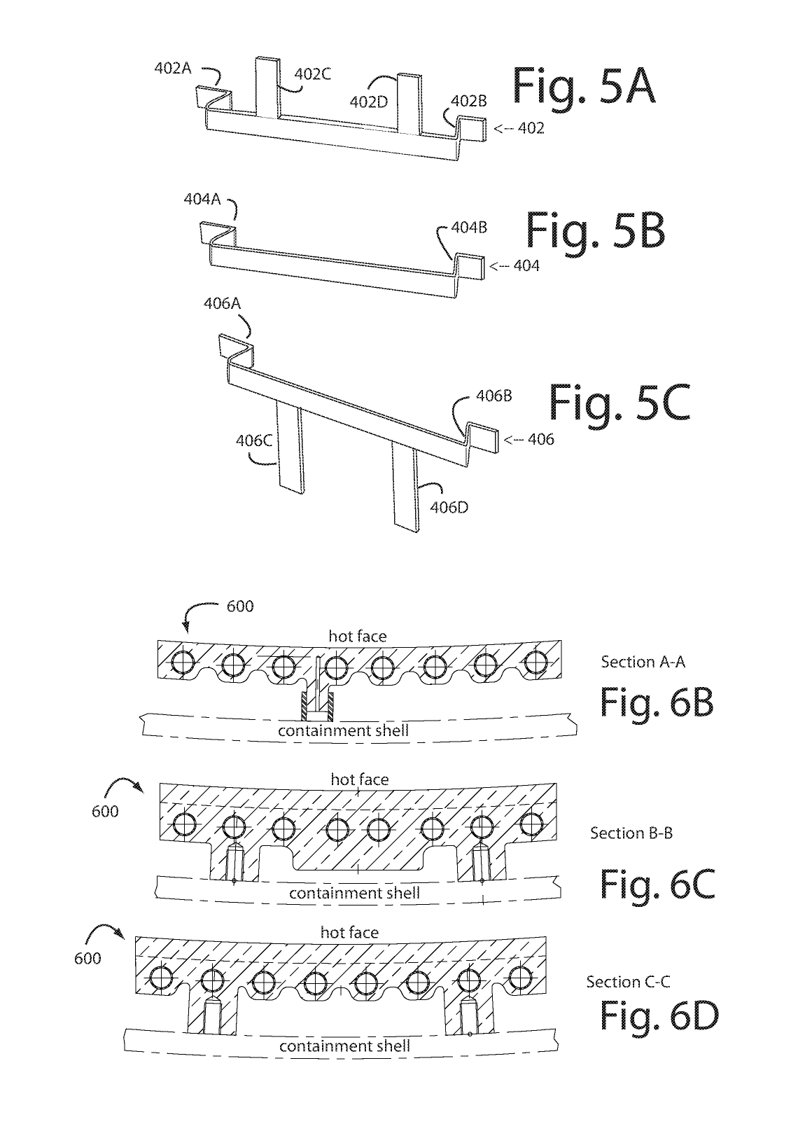

Although there may be better ways, like the rods in FIG. 4B, FIGS. 5A-5C represent chaplet straps 402, 404, and 406 in more detail. A pair of z-folded legs 402A-402B, 404A-404B, 406A-406B on the ends of each chaplet strap are dimensioned to stand upwards inside cope mold 304 and are primarily responsible for setting and adjusting copper cover (separation distance “d”). Such can be seen in FIG. 3. The individual z-folded legs can be independently adjust with simple bending.

The chaplet straps 402 and 406 further include top strut spacers 402C and 402D, and bottom strut spacers 406C and 406D. Inside cope mold 304 these set the in-service up-down relative position of CuNi pipe coils 400A, 400B, 400C, 400D. In-service, the CuNi pipe coils 400A, 400B, 400C, 400D operate stood up and vertical. In the mold, the hot face is laid on its face. And in-service, the hot face is vertical and facing into the furnace.

In general, any chaplets, straps, rods, supports, spacers, stabilizers, and wire ties that were necessary to position and hold the metal pipe coils in an optimal place relative to the hot face during the casting process are preferred to each substantially comprise a copper, a stainless steel, or a nickel alloy that comprises at least 20%-Wt copper, or copper alloy and at least 10%-Wt nickel.

Preferably, nothing in the way of a casting chaplet is placed in the drag mold 306 that would eventually be permanently entrained in the zone between the hot face and the front sides of the pipe coils facing the hot face, i.e., between hot face 210 and CuNi pipe coil 204 in FIG. 2. Otherwise, unwelcome shear forces will develop at dissimilar material interfaces under high heat flux conditions proximate to the hot face in a high heat flux cooler. Behind the CuNi pipe coils 400A, 400B, 400C, 400D is the only place left.

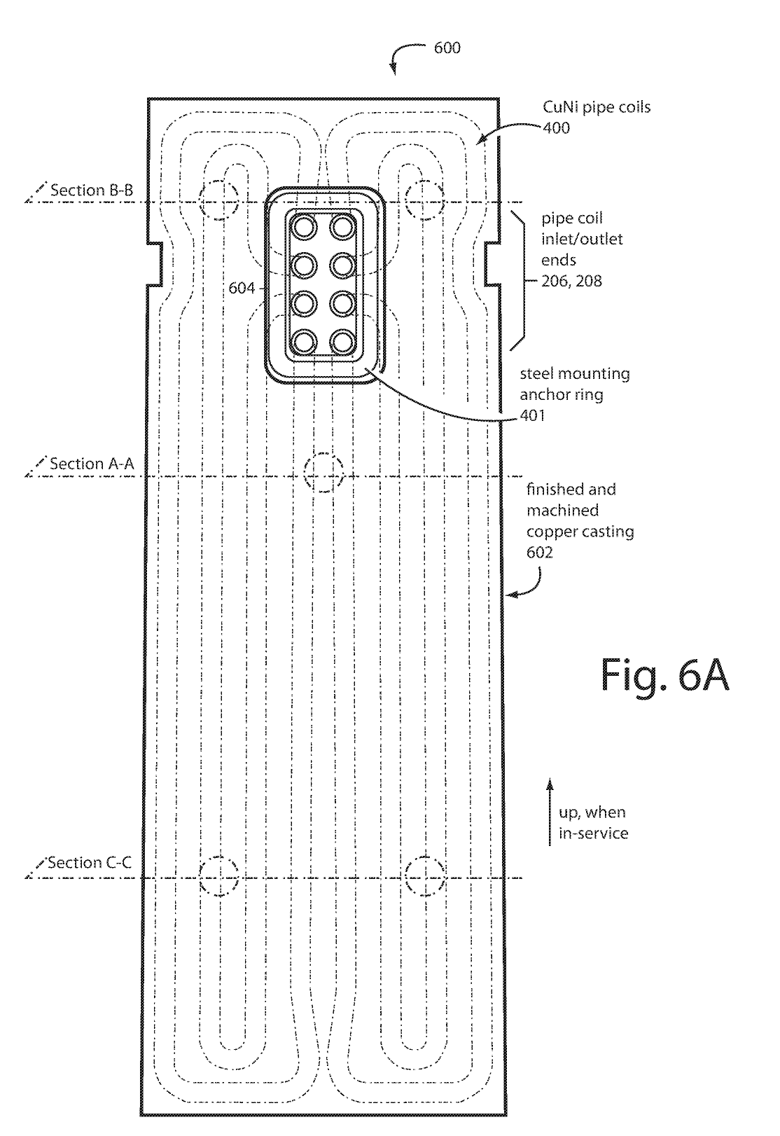

FIGS. 6A-6D represent a stave cooler 600 in an embodiment of the present invention that stands up vertically in service and can measure ten feet tall, four feet wide, and two feet thick. An example copper casting 602 is principally made of cast copper weighing 3,000 kg. The pipe coils 400 of FIG. 4 are cast into casting 602 using the molding method and equipment illustrated in FIG. 3. The cooling capacity of cooler 600 is split amongst four pipe coils 400A, 400B, 400C, 400D.

This is preferred over one pipe coil per stave cooler because a graceful shutdown can be initiated if any one of the four pipe coils fail. (Normal operations cannot continue with less than all pipe coils up and running.) Other manufacturers call this arrangement “intertwined” pipes, but strictly speaking the pipe coils are not intertwined because they are not twisted together. One does nest within another.

Putting a pipe coil behind the hot face coils would not be effective during normal operation as over 90% of the heat load to the cooler would be absorbed by the pipe coils nearer the hot face.

The copper cover in the hot face may need an allowance for wear resistance due to abrasion corrosion due to chemical attack. All designs should allow for some movement of the coils during the casting process. There is a further need to allow for flow of molten copper between the sand or support and the pipe coil, to ensure that a) gaps do not form if the copper freezes too quickly, and b) do not want the grains to align along the length of the pipe which could lead to a mechanical weakness or crack in the copper. The solid copper grains vary but are on the order of 0.25″ (6 mm), so it is preferable to have the gap of at least this large to minimize defects.

Copper is required between the pipe coils and the hot face in case of an intense heat load which could melt the surface. The copper acts as a thermal buffer to help distribute the local heat load. The front half of the pipe coils typically absorb about 70% of the heat load if it is properly set back from the hot face. If the pipe coils are too close a hot face, then there is a risk of film boiling of the fluid coolant inside the pipe due to insufficient distribution of the heat load.

If the pipe coils are too close to the hot face, then there will be bands of hot and cold copper, which can lead to thermally induced stresses and cracking. The actual pipe coil positions in a manufactured piece from casting are checked using ultrasonic testing. Such testing is calibrated to the type of copper, because the sonic velocities vary as a function of chemical composition and crystalline grain size.

If the pipe coils are too close to the hot face, then the pipe wall closest to the hot face will be hotter, which will cause thermally induced shear stresses between the cast in pipe and the cast around copper, which can lead to debonding.

Although copper is a good conductor, due to its specific heat, it takes time to heat up. Hence under unstable conditions the temperatures on the hot face can rise quickly before the cooling fluid begins carrying away the increased heat load.

If the pipe coils are too far from the hot face, then during normal near steady state operation the copper could run too hot and run the risk of a) oxidation if the temperature exceeds about 450° C., and/or b) plastic deformation creep or cracking due to thermally induced mechanical stresses.

If the pipe coils are too far from the hot face, then under unstable heat load conditions the copper could run too hot and run the risk of a) oxidation if the temperature exceeds about 450° C., and/or b) plastic deformation creep or cracking due to thermally induced mechanical stresses.

In embodiments of the present invention, the usual stresses at the interfaces of pipe coil surfaces with the cast copper do not exceed the yield stresses for the cast copper. This must be confirmed in FEA with three-dimensional finite element thermo-mechanical stress analyses. With FEA, it is practical to pre-qualify cyclic loading applications. The coefficient of thermal expansion for UNS C70600 90%, C71300 75%, C71500 70%, C71640 66%, or UNS C70600 copper-nickel alloy is about 9.0×10⁻⁶ in/in/° F., and 9.8×10⁻⁶ in/in/° F. for UNS C81100 cast copper. The differential then is only 0.8×10⁻⁶ in/in/° F. With the yield strength of cast copper being about 9.0 ksi, and 30-40 ksi for Monel-400.

Embodiments of the present invention pour hot liquid copper from a melting furnace into a ladle. A de-oxidant must be added-in if the copper was melted down in a non-inert environment. Any oxide slag is skimmed off. Oxygen can be readily picked up by molten copper transferring from the melting station to the casting mold. A sufficient superheat of the copper over its melting point is used to prevent the copper from prematurely solidifying during handling or pouring.

Liquefied copper from the ladle must be sufficiently fluid to fill the mold, and readily flow completely cover the pipe coils, and up inside to the top of its risers. Any gas bubbles are intended to rise high up to the top of the flooded surface. Once the deoxidized copper is poured into the mold from the ladle, the casting is allowed to cool until it has completely solidified. Any risers and gating systems are mechanically removed. Any excess material is machined or cut away, and additional hot face grooves and/or pockets are formed or finished to retain shotcrete, inserts, bricks, etc.

On the outside surfaces of newly cast and machined coolers, bolt holes are drilled and tapped to help with locating, mounting, or cooler lifting due to relatively low yield stress of the copper it is often necessary to embed helicals or metal to get the require strength around the threads. The coolers can be very large and very heavy. Any mating surfaces between coolers are machined. The amount of machining needed is dependent on the end use for the cooler. Surface imperfections are repaired by grinding, welding, and machine smoothing.

The completed coolers are visually inspected, x-rayed, sent through infrared-thermal inspection, and then hydrostatic or pneumatic pressure tested for coolant leaks flow tested for pressure drop before and after casting. A ball test verifies none of the pipes has collapsed or other serious defect developed. Electrical conductivity testing is used to indirectly verify that the cooler's copper metal purity and thermal conductivity meets minimum standards. Pipe welds are normally inspected prior to casting using x-rays and/or liquid dye penetrants.

Dimensional tolerances for the particular application are checked after casting. Samples are destructively tested, and a predetermined percentage of the total number of identical or similar coolers to be manufactured are cut open and inspected. Coolers with steel and/or iron pipes and tubes cast inside the copper have several advantages. Pipe coil can be inexpensive and very easy to manufacture, bend, weld, and join with fittings. Steel and iron pipe coils do not come close to melting when the molten copper is poured into the mold. The resulting coolers will then have well-defined water passages.

But the disadvantages of using steel and iron pipe coils includes associated problems with gas bubbles, porosity, gaps, and poor pipe-to-casting fusion. Such defects are observable with x-ray imaging and destructive testing.

Cast copper can not form a good metallurgical bond with the outside surfaces of steel and iron pipes. Destructive testing proves steel and iron pipes always separate easily from the cast copper. If they had fused and bonded, it would be difficult to separate afterwards. Destructive testing samples are usually sliced up 0.25 to 1.00 inches thick to fully expose the pipe coils' cross-sections. Just cutting across through the slice will show that such pipes are not mechanically locked-in. This is usually sufficient to confirm a poor steel-to-copper bond. Steel and iron pipes will often just fall out on their own, even before being touched by a pneumatic chisel.

The lack of bonding sharply increases thermal resistance. Heat transferring from the copper to the pipe piles up, and little of that heat gets carried away in the coolant. These coolers run hotter than alternatives that use copper pipes.

There are also large differences in the coefficients of thermal expansion between the steel in the pipe coils and the cast copper shear forces can make bondings fail. Stresses at the pipe-copper interface can easily exceed the copper yield-stress, so the copper in the cooler will crack under even normal thermal cycling. The coefficients of thermal expansion are about 6.9×10⁻⁶ in/in/° F. for steel, and 9.8×10⁻⁶ in/in/° F. for UNS C81100 cast copper.

Stainless steel pipes or tubes with copper cast around them have a unique set of advantages. Stainless steel pipe coil is somewhat more expensive than steel or carbon pipe, but is relatively easy to manufacture, bend, weld, and make fittings. The stainless steel pipe coils will not melt when molten copper is poured around them in a mold. Stainless steel does not contaminate the copper. These coolers can also have well-defined water passages.

The disadvantages of stainless steel pipe coils are less pronounced and less common. But gas bubbles, porosity, gaps and other signs of a lack of good fusion are common at the interfaces of the pipe with the copper casting. Molten copper does not wet the outside surfaces of stainless steel pipe to form a good metallurgical bond. Destructive tests have proven stainless steel pipe can be easily separated after casting it inside cast copper body. No metallurgical bond is present for good heat transmission.

Monel-400 pipes and tubes cast inside copper coolers are advantageous in that the Monel-400 does not melt when molten copper is poured into the mold. Its melting point is substantially higher. So the resulting coolers can always be expected to have retained the well-defined water passages of the pipe provided the pipe does not soften and collapse. Molten copper also wets Monel-400 very well. Nickel and copper have a high affinity for one another. So the pipe coil and copper casting are predisposed to forming tight, intimate interfaces.

As a test of the degree of bonding Monel-400 pipe coils can achieve, a pneumatic chisel can usually manage to separate them from copper cast bodies in destructive tests. On close inspection of the separated pieces, copper particles amounting to less than 10% of the total surface area cover the Monel-400 pipe. That means 90% of the surface area of a typical Monel-400 pipe section will remain not bonded, both mechanically and metallurgically. Any interface of pipe to copper is normally clearly visible on an x-ray. When using ultrasonic testing, there is normally an echo at the outside of the pipe, which reveals a lack of pipe bonding.

Monel-400 pipe coil is an expensive pipe coil commercially used with cast copper, due to its high nickel content it is much more difficult to manufacture. Monel-400 pipes used in coolers made with them represent about 30% of the cost of the casting. This is due in part to cost of standard returns and fittings in Monel-400, and are more difficult to obtain than their counterparts in stainless steel, carbon steel, or iron pipe. In summary, cast copper does not easily form good metallurgical bonds with the outside of the Monel-400 pipes. Pure nickel is even more expensive than Monel-400, but pure nickel does not bond any better.

Some distortion of even Monel-400 pipe coil typically occurs during casting. Internally shoring up the Monel-400 pipe coil with a sand mixture is sometimes needed. Gas bubbles, porosity, gaps and other signs of lack of fusion are not common at the interface of the pipe with the copper, provided precautionary steps are taken to clean up the pipe coil surfaces. There may be good initial mechanical contact after casting.

During the cooler's operation in service, heat transfers from the copper to the Monel-400 pipe are limited where the metal did not fuse well at the pipe-copper interface.

The state of stress at the Monel-400 copper interface will exceed the yield stress of the copper, even at moderate thermal loads. Progressive failures will occur if there is to be any thermal cycling. The coefficient of thermal expansion for Monel-400 is about 7.7×10-6 in/in/″ F., compared to 9.8×10-6 in/in/″ F. for UNS C81100 cast copper.

However, Monel-400 pipe in cast copper coolers can be expected to deliver good service if used in near steady-state operations. I.e., limited thermal cycling.

Pure-copper pipe coil is attractive because it is much less expensive than Monel-400, albeit still more expensive than carbon steel or iron pipe. Pure-copper pipe coil is relatively easy to manufacture, bend, weld, etc. And the finished coolers can enjoy well-defined water passages that include substantially good bonding of the copper pipe surfaces to the cast copper.

Pure-copper pipe coil cast copper coolers tend to function the coolest of all, but only in instances where the cast copper actually did fuse and bond with the outside surfaces of the pure-copper pipe coil. The interface of the pipe coil with the cast copper will be seen in testing to be quite clean. However, conventional cast copper coolers do not ordinarily reach good internal metallurgical bonding.

In practice, the pure-copper pipe coils soften too much, and even melt if used in large castings. A catastrophic melt-through of the pipe is possible, particularly near the corners. So the pure copper pipe coils must have coolants run through inside them during the casting pour. Experience also shows that when coolants are run through they generate strong vibrations inside just when the cooling liquid copper pour needs to be very still. The coolants generate vibrations when they swirl, cavitate, film boil, and even pulse due to steam generation. The vibrations interfere with proper copper crystal grain formation.

The hot liquid copper pour will completely fill the interior design contours of the mold and therefore be at its maximum swell due to the coefficient of expansion. As the casting cools, it shrinks. If the pipe coils are not tracking the same temperatures, because they are being cooled, they will not swell and shrink in step with the casting inside the mold. The differences concentrate as large shear forces at the very interface that needs to fuse and bond.

Melt-through in various spots can occur during casting if the cooling is uneven and on the outsides of pipe bend radii where the walls are thinner. In comparison to any other type of pipe coils, pure-copper pipe coils must also have much thicker walls to stave off spot melt-throughs. The equivalent of a Schedule-120 or Schedule-160 is normally used for pure copper, compared to Schedule-40 or less for the other pipe coil types.

A very serious adverse consequence of resorting to thicker walls is the center-to-center spacing of water passages must be proportionately larger. The total surface area of water contact within the cooler will be substantially reduced. The consequence of that is, unfortunately, the equilibrium heat removal capacity of pure copper pipe coils is much less than if Monel-400 had been used. Considerable foundry experience has been needed to find the “right” amount of cooling to apply during casting.

Copper pipe coils, especially those plated with nickel, are far better than those with iron. That is when it comes to limiting the adverse formation in the copper casting of gas bubbles, porosity, gaps, a lack of metal fusion, and contamination. If too much cooling of the pipe coils is applied during the casting pour, good metallurgical bonds to the outside of the pipe are inhibited. But, if too little cooling is applied, spot melt-throughs in the walls of the copper pipe will develop.

Significant melt-throughs can be severe sufficient to collapse the walls and obstruct cooling water flow. Even a little of this can render the cooler unusable. If liquid molten copper breaches the pipe and contacts coolant water, a dangerous steam explosion like a BLEVE can occur. So the technique can be dangerous and destructive.

Both pure-copper pipe and Monel-400 pipe in cast-copper coolers have provided good service over the years for moderate and cyclic thermal loading, but then only if the coolers are carefully designed and well made.

Instead of pipe coils, sand-cores have also been used to define water passages within a copper casting. The loose sands are blended with organic binders that dry and agglomerate temporarily into the required core shapes. However, pieces of agglomerated sand can nevertheless break off and wander around during casting, and thus ruin any water containment. The sand is easily knocked loose after the liquid copper has cooled and solidified. The sand-core techniques are much less expensive than using any internal pre-formed metal pipe coils.

The coolers resulting from sand-core castings can enjoy very well-defined water passages. The cooling water will be in intimate contact with the cast copper cooler, and that maximizes heat transfer. Best of all, no pipes in-between that need to be bonded. But designing water passages with sand-cores is much less flexible than using preformed pipe coils because the sand-cores must be mechanically supported with spacers, struts, wire ties, and other devices up until the liquid copper sufficiently freezes around them.

Gas bubbles, porosity, gaps and fusion defects can occur with sand-core castings too. The insides of the water passages will never be as smooth as with pipes, and the coolant turbulence introduces higher hydraulic gradients in the coolant circulation. Meaning larger, expensive supply pumps and piping will be needed.

The rejection rates of cast copper coolers made with sand-cores is higher than what is typical for those comprising high melting point pipes. The lack of any internal pipe coil in the sand-core castings increases the risk of a potential leak.

The sand-core type copper castings can finish permeated with gas bubbles if not vented during the casting. The cores must be supported up until the cast copper cools and freezes, because they would sag otherwise. Any steel vent/support pipes in the sand-cores must be sealed with plugs and/or welds to make them gas-tight. A presence of steel pipes is a significant source of porosity, and through-thickness defects. Without pipes, the defects can cause leakage.

Sand-core cast copper coolers tend to run the coolest of all types, due to an absence of thermal resistance the pipe coils would inject.

Coolers with steel, cast iron, nickel-copper alloy (NiCu), copper-nickel (CuNi) alloy, or copper water pipe coils inside coolers are conventional in castings. For example, in the fabrication of plate coolers for iron and steel metallurgical furnaces, blast furnaces, direct reduction reactors, and gassing units with refractory linings.

Coils of thick-walled copper pipes patterned into shape are conventionally arranged inside a mold, and molten copper is poured from above directly into the mold. A few variations on copper alloys have been tried over the years. As always, intimate bonding of the cast copper cooler to the cooling pipes inside is the goal necessary to realizing adequate cooler thermal efficiencies. A slight, very shallow skin melting of the thick-walled pipes is promoted to occur briefly during the pouring to reach fusion.

Water leaks at the plugs is possible with both drilled and plugged coolers, and also castings with sand core passages. Castings with an internal pipe coil are preferable for applications requiring maximum safety against a water leak.

Several applications demand a minimum in leak potential: (1) slag launders, where water could cause a steam explosion; (2) the roof or walls of a furnace, where even a small water leak over time can lead to hydration of basic refractory or possible explosion, (3) tap hole coolers and face plates where water could cause a steam explosion.

Castings with internal pipe coils avoid the need for welded plugs to cover internal casting supports.

Embodiments of the present invention comprise thermal modelling. The heat removal characteristics of high heat flux cooler coolers 106, 108 can be estimated using finite element analysis (FEA) computer modelling. However, FEA will not be able to account for chemical corrosion and mechanical erosion aspects at the hot face. FEA can be used to estimate the temperature distribution within the casting in operation, as well as any material in front of the hot faces, i.e., for constant surface temperature, applied heat flux, and other specified boundary conditions. A three-dimensional (3D) finite element model can be built for various alternatives, i.e., (A) Pipe coil material: copper, NiCu (UNS N04400); and (B) Hot face pattern: smooth face, rectangular grooves, rectangular pockets, pins, etc.

One computer model can be used for each case. The heat in must equal the heat out. Choices of pipe materials do not have much affect on this because the pipe walls are relatively thin. But a loss of bonding can have a dramatic impact. Bonding losses can be approximated in mathematical modelling. The FEA models can be run as steady state. Thermal conductivities can be varied with temperature. Based on FEA modelling, temperatures inside the pipe coils did not vary significantly with changes in either the type of pipe (copper or NiCu) or whether the hot face pockets or grooves were filled with either castable or pure copper.

For example, with an applied heat flux of 50,000 Btu/ft²/hr (158 kW/m²) under steady state conditions, all of the heat must always be removed at the pipe/water interface, since heat coming in must equal the heat going out, regardless of pipe materials or hot face surface patterns.

Mechanical stresses are calculated based on the thermal results. Material properties are varied with temperature, for both the coefficients of thermal expansion and the modulus of elasticity. The maximum tip temperatures of high heat flux cooler coolers 106, 108 increases slightly with changes in the pipe coil materials. As nickel content is increased in a copper pipe coil, the temperatures on the outside of the pipe coil increase proportionately, due to the decreases in the thermal conductivity of the pipe coil.

Stresses at the hot face of the copper change little with variations in the pipe coil material, because the thermal resistance of the thin walls of pipes is small. But stresses will proportionately increase with the applied heat flux. The stresses at a pure copper pipe coil to cast-around copper interface is significantly lower than when the pipe coil is Nickel-Copper (NiCu) pipe, if the pipes are bonded to the cast copper. For an applied heat flux of 50,000 Btu/ft²/hr (158 kW/m²), the stresses at this interface can be 2,200 psi and a much higher 14,100 psi (15.2 MPa and 97.2 MPa) for copper and NiCu pipe, respectively. Destructive testing has revealed the yield stress of the cast-around copper can vary 9,000-14,000 psi (62-97 MN/m2). If the heat flux is cycled, such as occurs normally in a slag or matte launder, fatigue and separation of the pipe coil is likely since the instantaneous heat flux can often exceed 100,000 Btu/ft²/hr (315 kW/m²).

Early on in the development of the present invention, this all lead to the understanding that pipe coils 110, 112, 114, 116 should comprise a copper-nickel (CuNi) of at least 70%-Wt copper, and the copper cast bodies of high heat flux cooler coolers 106, 108, should be a copper alloy of at least 50%-Wt copper. The pipe coils should not be cooled during casting. Alternatively, the pipe coils should be packed with sand. In another embodiment, the pipe coils 110, 112, 114, 116 should comprise UNS C70600 90%, C71300 75%, C71500 70%, C71640 66%, or UNS C70600 copper alloy, and the copper cast bodies of high heat flux cooler coolers 106, 108, should start as high purity copper (99%-Wt) that finishes as an approximation of UNS C81100. A maximum wall thickness equivalent to ASTM Schedule-40 was determined to be appropriate.

Preferred cooler embodiments of the present invention comprise a casting of liquid high purity (99%-Wt) copper with only a deoxidant added during a casting process and that is three-dimensionally formed to fit a pyrometallurgical furnace. At least one hot face is included and intended to face a substantial heat flux during use that is severe sufficient to threaten significant cracking, wear, and/or melting of the hot face.

A metal pipe coil that is substantially comprised of copper in an alloy, is oriented and disposed relative to the hot faces within the casting. Such is configured that an inlet end and an outlet end of the metal pipe coil are externally accessible for the circulation of a coolant.

A metallurgical bond is important to achieve that is a skin fusion of a substantial portion of the outside surfaces of the metal pipe coil with the casting. The thickness of the walls of the metal pipe coil are reduced near to a minimum necessary that avoids spot softening and collapse during a casting pour of the casting in a mold. This may need to be empirically determined.

The alloy used in the walls of the metal pipe coil has a near minimally different and higher melting point that sidesteps spot softening and collapse during a casting pour of the casting in the mold.

Any supports, spacers, straps, stabilizers, and wire ties that were prudent and/or necessary to position and hold the metal pipe coil in an optimal place relative to the hot face and any other surfaces during the casting of liquid high purity (99%-Wt) copper are abandoned in place. They are unavoidably forever entangled, embedded, dissolved, or otherwise entrained after the casting cools and solidifies. And so, the supports, spacers, stabilizers, and wire ties are preferred to each substantially comprise a copper, a stainless steel, or a nickel alloy of at least 20%-Wt copper, or copper alloy, and at least 10%-Wt nickel.

The pyrometallurgical furnaces applications herein include any furnace for the production of one or more of molten metal, metal alloy, matte, or slag. The coolers are dimensionally formed and finished in shapes variously suitable for service as a launder, a runner, a cooler, a wall cooler, a roof cooler, a burner block, a tuyere, a casting mold, an electrode clamp, a tap cooler, or a stave cooler.

Alternatively, the metal pipe coil is substantially comprised of copper in a copper-nickel alloy (CuNi). And alternatively, the metal pipe coil is substantially comprised of UNS C70600 90%, C71300 75%, C71500 70%, C71640 66%, or UNS C70600 schedule-40 water pipe that has been cast inside a pour of liquid high purity (99%-Wt) copper. In one alternative embodiment, the casting is poured from liquid high purity (99%-Wt) copper comprising a minimum of 99%-Wt copper.

In all embodiments the metal pipe coil must be oriented and disposed at a depth relative to the hot face according to an intelligence result obtained for a particular design and a specific application of the cooler using iterative computational fluid dynamics (CFD) and/or finite element analysis (FEA) analyses and modelling.

In all embodiments, the coolers must at a minimum be dimensionally formed and finished in a shape suitable for service as a launder, a runner, a cooler, a wall cooler, a roof cooler, a burner block, a tuyere, a casting mold, an electrode clamp, a tap cooler, or a stave cooler in a pyrometallurgical furnace for the production of at least one of molten metal, metal alloy, matte, or slag, and comprising a pipe coil disposed inside the cooler relative to any surface and at a depth and a position derived from an intelligence obtained for a particular design and a specific application of the cooler using iterative computational fluid dynamics (CFD) and/or finite element analysis (FEA) analyses and modelling.

The finished depth and position of the pipe coils 110, 112. 114, 116 strike a balance between too deep that would permit surface melting, and too shallow that would disturb metal grains and result in cracking and coolant leaks. These pipe coils all require an inlet end and an outlet end that are externally accessible for the circulation of a coolant.

One pipe coil is the minimum, additional pipe coils, all similar to, separate and independent from the first pipe coil, can also be added-in as a failsafe backup to the first pipe coil. Four such pipe coils and the grouping are shown in FIGS. 4 and 6.

In summary, coolers are not normally required below a steady state heat flux of 5 kW/m². Above that, the refractory will typically tend to wear.

In general, coolers are not placed within a metal zone, or superheated low grade copper matte, or nickel matte. Notwithstanding, it was been done. Coolers that were designed for a direct to blister furnace to produce blister copper metal, using a composite furnace module design (it included horizontal tapered pins which had not been done before). Those worked very well, and continue to do so.

From an engineering design perspective, the tolerances imposed on pipe location are with respect to a final casting. It must be recognized that the pipe coils can shift during casting, and the some surface need to be machined. Care must be taken when designing castings with holes that are to be drilled later, allowances must be included for movement, hence the need to impose tolerances on a fabricator. Tolerances are routinely put on all surface and hole locations for these reasons.

If the pipe coils wander too close to an as-cast surface, then the metal may solidify without fully surrounding the pipe. A minimum of 5/16″ to a cold face should always be observed. (Some think ⅝″ is a better minimum, but that can waste a lot of expensive copper.) Pipes can easily move ⅛″ in small castings, and even more in large castings. These items must be put onto drawings the fabricator is to confirm that they can make to the required tolerances (pipe positions, cast in inserts, and as cast and machined surfaces and holes).

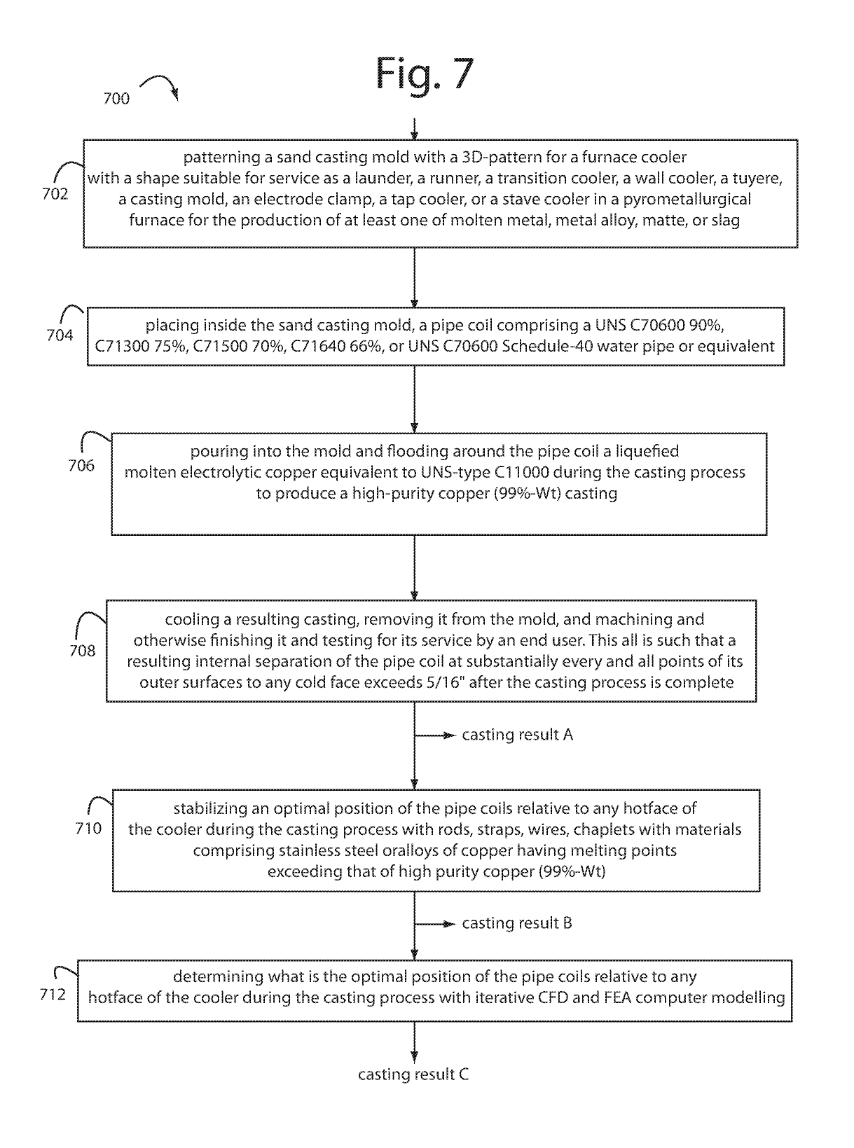

FIG. 7 represents a method 700 for manufacturing a particular type cooler for an application in a particular type furnace that will be subject to an estimated high level heat flux greater than 25 kW/m² average, and that further involves the casting of CuNi pipe coils in a copper casting. The method 700 comprises a step 702 for patterning a sand casting mold with a 3D-pattern for a a furnace cooler with a shape suitable for service as a launder, a runner, a cooler, a roof or wall cooler, a tuyere, a casting mold, an electrode clamp, a tap cooler, or a stave cooler in a pyrometallurgical furnace for the production of at least one of molten metal, metal alloy, matte, or slag. A step 704 places inside the sand casting mold, a pipe coil comprising a UNS C70600 90%, C71300 75%, C71500 70%, C71640 66%, or UNS C70600 Schedule-40 water pipe or equivalent. A step 706 is for pouring into the mold and flooding around the pipe coil a liquefied molten high purity (99%-Wt) copper during the casting process to produce a high-purity copper casting approximating UNS-type C11000. The pour may need to have a deoxidant added. A step 708 is for cooling a resulting casting, removing it from the mold, and machining and otherwise finishing it and testing for its service by an end user. This all is such that a resulting internal separation of the pipe coil at substantially every and all points of its outer surfaces to any cold face exceeds 5/16″ after the casting process is complete.

A step 710 is for stabilizing an optimal position of the pipe coils relative to any hot face of the cooler during the casting process with strapping, rods, chaplets, and other devices with materials comprising stainless steel of alloys of copper having melting points substantially exceeding that of UNS C70600 90%, C71300 75%, C71500 70%, C71640 66%, or UNS C70600 copper. A step 712 is for determining what is the optimal position of the pipe coils relative to any hot face of the cooler during the casting process with iterative CFD and FEA computer modelling.

The computer-aided decision on how deep the pipe coils should be submerged inside the casting from a particular cooler's hot face requires several starting conditions to be expertly assumed or given by the end user or experience.

First of all, the average heat flux is an independent variable that pushes a particular cooler application into our regime. Embodiments of the present invention provide solutions for high average heat flux above 25 kW/m². Below that, conventional coolers and casting methods are performing well. The present Method then includes a large safety margin that can accommodate a long lasting steady state furnace upset. So the Method begins by multiplying the given average heat flux by a factor of four to set the minimum capability of the cooler, i.e., 100 kW/m² if the starting condition is 25 kW/m².

As a rule, a large factor of safety like four-times is necessary to accommodate upset conditions in the furnace, and to ensure the cooler is not the “weak link” in the furnace shell-refractory-cooler crucible system. Some designers use a safety factor of two-times, but step changes in furnaces greater than two-times have been observed.

The safety margin means that sufficient copper in the casting between the pipe coils and the hot face must be positioned to thermally buffer and distribute the heat load. Such a buffer prevents the appearance of an isotherm ripple across the hot face that will generate thermal shear forces and stresses that cause grain cracking. CFD and FEA computer modelling must confirm in their final iterations that the cooler can perform properly with what might be too little casting metal inside between the pipe coils and the hot face.

The front facing hemispheres of the individual pipes in the pipe coils can be assumed to absorb 70% of the incoming heat flux. Film boiling inside the pipe coils of the pipe coil can occur if this lopsided heat absorption phenomenon is not recognized and the pipe coils are unknowingly set too close to the hot face. The lopsided heat absorption phenomenon also causes shear forces to develop at the pipe surface interfaces with the casting, and if that gets too severe, the pipe coils will de-bond and the thermal resistance will increase dramatically. CFD and FEA computer modelling must confirm in their final iterations that the cooler can perform properly with what might be too little casting metal inside between the pipe coils and the hot face.

CFD and FEA computer modelling must confirm in their final iterations that the cooler can accept and dispose of four times the given starting condition for heat flux. I.e., 100 kW/m² if the starting condition is 25 kW/m².

The next given starting condition comes from the end user, what will be the campaign life required, stated in years.

Every cooler may be subjected to wear. Some more than others. A starting condition for the rate of wear must be given, i.e., one millimeter per year. So for a campaign life of five years, wear will have reduced the hot face closer to the pipe coils by five millimeters. CFD and FEA computer modelling must confirm in their final iterations that the cooler can perform properly with the hot face reduced by (wear rate)×(campaign years).

Every cooler will be subjected to corrosion. Some more than others. A starting condition for the rate of corrosion must be given, i.e., one millimeter per year. So for a campaign life of five years, corrosion will have reduced the hot face closer to the pipe coils by five millimeters. CFD and FEA computer modelling must confirm in their final iterations that the cooler can perform properly with the hot face reduced by (corrosion rate)×(campaign years). If wear and corrosion are both significant, then [(wear rate)+(corrosion rate)]×(campaign years).

During casting, the pipe coils will shift despite best efforts. An allowance for this shift must be budgeted. I.e., ±two millimeters. So, in this example, two more millimeters of casting material must be added between the pipe coils and the hot face they service. CFD and FEA computer modelling must confirm in their final iterations that the cooler can perform properly with this allowance added for pipe coil shifting during casting.

The pipe coils should not ever get closer than 5/16″ inside the casting to any cold face. Liquid copper during the casting process must have good sufficient access to fill all voids and without letting the copper to freeze to quickly. The grains of copper that crystalize during cool down will be too small if the freeze occurs too quickly. Large crystals take time to grow. As a general rule, grains that are ¼″ (6 mm) in size need to be allowed to form to minimize crystal grain defects. CFD and FEA computer modelling must confirm in their final iterations that the cooler can perform properly with this 5/16″ minimum inside cold face separation allowance.

Pushing the balance the other way, If the pipe coils are in too deep inside from the hot face, and even during normal, near steady state operation, the cast copper in the hot face surface can run so hot as to run the risks of,

a) oxidation if the spot temperatures exceed about 450° C., and

b) local surface plastic deformation creep or cracking due to thermally induced mechanical stresses.

CFD and FEA computer modelling must confirm in their final iterations that the cooler can perform properly with what might be too much casting metal inside between the pipe coils and the hot face. Copper is expensive, and too much copper would waste money.

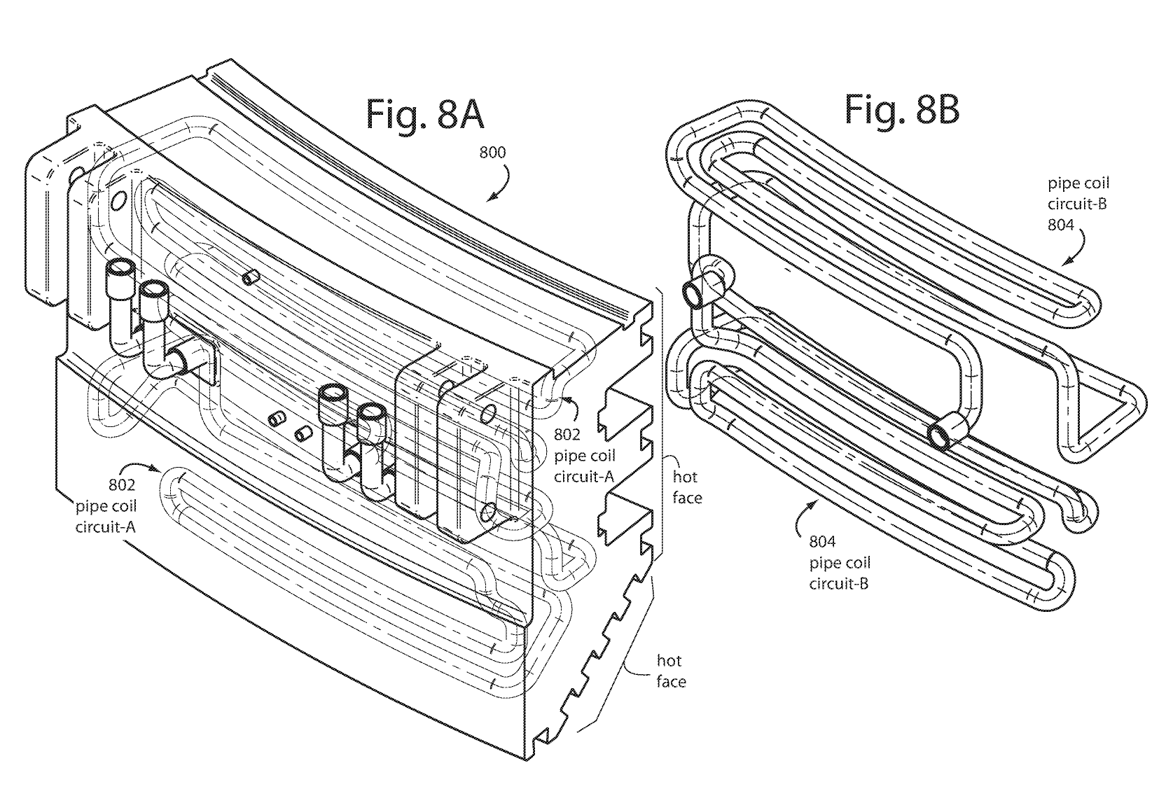

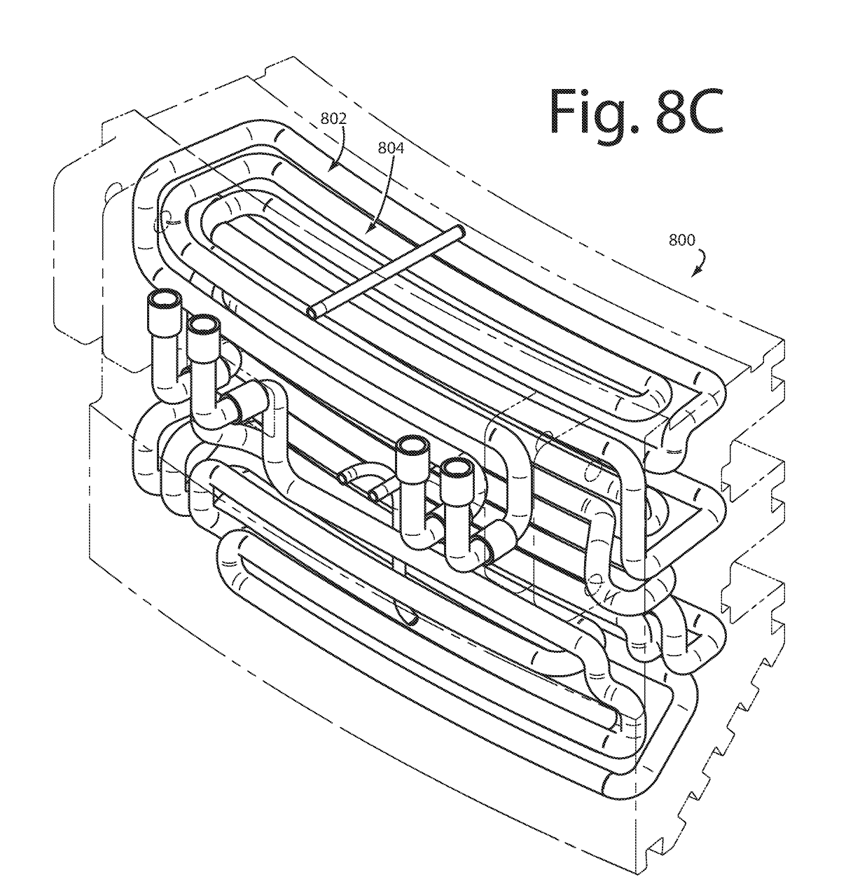

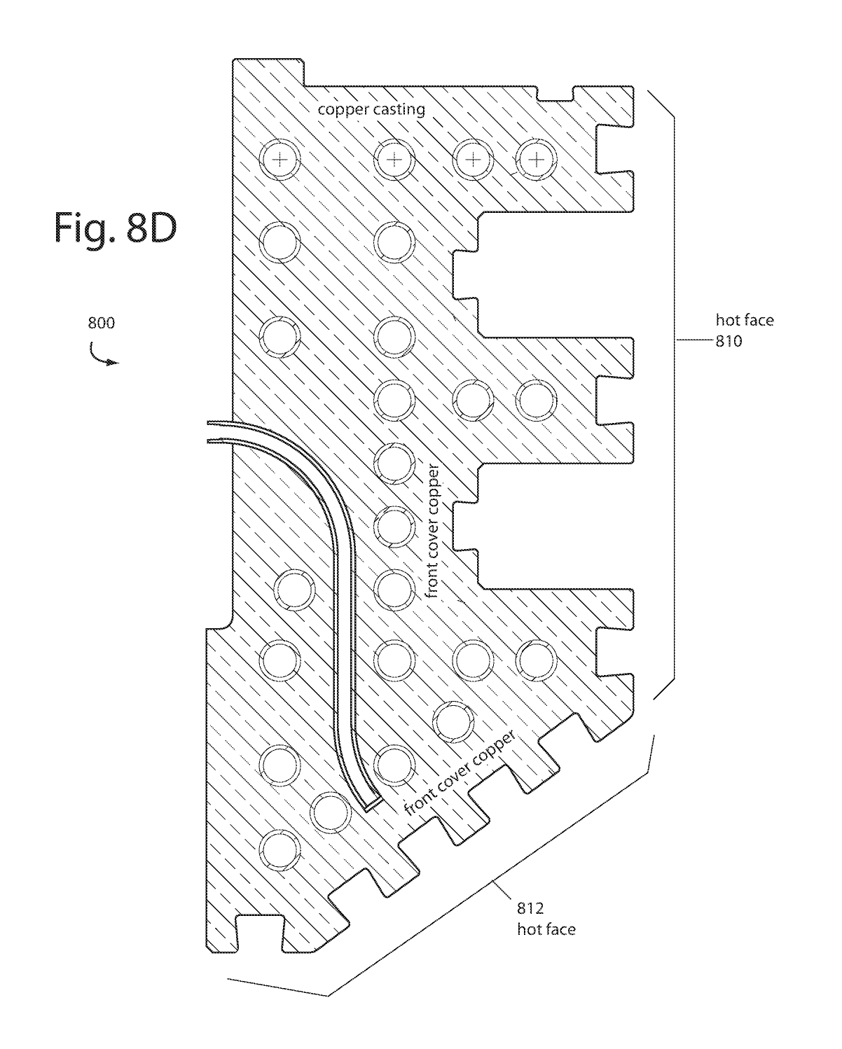

FIGS. 8A-8D represent a high heat flux transition cooler 800 as would be used in an Outokumpu or Inco Flash furnace, or any furnace with a gas offtake through the roof. It includes two circuits of CuNi pipe coil 802 and 804. There are two hot faces 810 and 812 that both as a pair get a front cover copper in the high purity (99%-Wt) copper casting.

Calling attention to FIGS. 8A and 8A, cooler 800 depends on two, essentially parallel pipe coil circuits A and B, 802 and 804 to carry heat out. It is important that each evenly cool the whole of cooler 800 throughout to avoid the unnecessary development of thermal stresses.

The even distribution of cooling efficiencies requires that the two pipe coil circuits A and B, 802 and 804 must be twisted and intertwined inside in a way that each still fits with the other and with the cooler, and that still evenly services every zone inside. The pressure drops between the two pipe coil circuits A and B, 802 and 804 must be nearly the same so the same flows of coolant pass through. It helps to alternate “A” and “B” coolant connections in daisy chains of coolers 800 in a furnace.

Employing the two pipe coil circuits A and B, 802 and 804 in one cooler 800 allows a pipe coil surviving a furnace upset to continue operation during a graceful shutdown. More that two pipe coil circuits allows for an even greater division and sharing.

FIGS. 8A-8D represent a practical cooler 800 in an embodiment in which the two pipe coil circuits A and B, 802 and 804, actually were modelled with CFD and FEA to have satisfied these goals in a practical and real-world application.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A high heat flux cooler, comprising:
a casting of liquid high purity (99%-Wt) copper with only a deoxidant added during a casting process and that is three-dimensionally formed to fit a pyrometallurgical furnace, and that includes at least one hot face intended to face a substantial heat flux during use that is severe sufficient to threaten significant cracking, wear, oxidation, and/or melting of the hot face;
a metal pipe coil substantially comprised of copper in an alloy, and that is oriented and disposed relative to the hot faces within the casting, and is further configured such that an inlet end and an outlet end of the metal pipe coil are externally accessible for the circulation of a coolant;
a metallurgical bond is fused between a substantial portion of the outside surfaces of the metal pipe coil and the casting;
a sacrificial scaffolding of supports, spacers, straps, stabilizers, rods, and wires that were necessary to position and hold the metal pipe coil in an optimal place relative to the hot face and any other surfaces during the casting of liquid high purity (99%-Wt) copper are unavoidably forever entangled, embedded, dissolved, or otherwise entrained after the casting cools and solidifies;
wherein, the thickness of the walls of the metal pipe coil is reduced near to a minimum necessary that circumvents spot softening and collapse during a casting pour of the casting in a mold; and
wherein, the alloy in the walls of the metal pipe coil has a near minimally different and higher melting point that circumvents spot softening and collapse during the casting pour.

2. The high heat flux cooler of claim 1, wherein:
the pyrometallurgical furnace comprises any furnace for the production of one or more of molten metal, metal alloy, matte, or slag; and
the high heat flux cooler is dimensionally formed and finished in a shape suitable for service as a launder, a runner, a cooler, a wall cooler, a roof cooler, a burner block, a tuyere, a casting mold, an electrode clamp, a tap cooler, or a stave cooler.

3. The high heat flux cooler of claim 1, wherein:
any supports, spacers, stabilizers, rods, and wires that were necessary to position and hold the metal pipe coil in an optimal place relative to the hot face during the casting are themselves each substantially comprised of a copper, a stainless steel, or a nickel alloy comprising at least 20%-Wt copper, or copper alloy and at least 10%-Wt nickel.

4. The high heat flux cooler of claim 1, wherein:
the metal pipe coil is substantially comprised of copper in a copper-nickel alloy (CuNi) and is not cooled during the casting pour.

5. The high heat flux cooler of claim 1, wherein:
the metal pipe coil is substantially comprised of UNS C70600 90%, C71300 75%, C71500 70%, C71640 66%, or UNS C70600 schedule-40 water pipe that has been cast inside a pour of liquid high purity (99%-Wt) copper.

6. The high heat flux cooler of claim 1, wherein:
the casting is poured from liquid high purity (99%-Wt) copper comprising a minimum of 99%-Wt copper.

7. The high heat flux cooler of claim 1, wherein:
the metal pipe coil is oriented and disposed at a depth and with an initial copper cover relative to the hot face according to a result obtained for a particular design and a specific application of the high heat flux cooler using iterative computational fluid dynamics (CFD) and/or finite element analysis (FEA) analyses and modeling.

8. A high heat flux cooler that has been dimensionally formed and finished in a shape suitable for service as a launder, a runner, a transition cooler, a wall cooler, a roof cooler, a burner block, a tuyere, a casting mold, an electrode clamp, a tap cooler, or a stave cooler in a pyrometallurgical furnace for the production of at least one of molten metal, metal alloy, matte, or slag, and comprising:
a CuNi pipe coil disposed inside a high purity (99%-Wt) copper casting of a high heat flux cooler and separated by a front copper cover, and at a position relative to an included hot face surface, and having the position previously fixed inside a copper casting mold that was verified for manufacturing from iterative computational fluid dynamics (CFD) and/or finite element analysis (FEA) analyses and modeling as suitable at a given end-of-campaign-life state;
wherein any of the front copper cover remaining in a prediction for the end-of-campaign-life state accounts for any initial estimates of oxidation, wear and/or corrosion rates bearing on the hot face at a design average heat flux in excess of 25 kW/m².

9. The high heat flux cooler of claim 8, wherein the cooler has a heat removal capacity able to continuously operate safely during a furnace upset that continuously exposes it to a transient heat flux of at least four times the design average heat flux in excess of 25 kW/m².

10. The high heat flux cooler of claim 8, wherein the copper cover relative to the hot face surface strikes a balance between too much copper cover that could not prevent surface melting, and too little copper cover that would allow a disruption of copper metal grains and result in cracking and coolant leaks when in-service.

11. The high heat flux cooler of claim 8, wherein the pipe coil is further configured such that an inlet end and an outlet end of the metal pipe coil are externally accessible for the circulation of a coolant.

12. The high heat flux cooler of claim 11, further comprising:
at least one additional and separate pipe coil similar to and independent from the first pipe coil;
wherein a total heat load on the cooler is shared amongst more than one pipe coil and reduces the severity of any failure of any one pipe circuit to function to carry away heat.

13. A method of manufacturing a furnace cooler for an estimated in-service high level heat flux greater than 25 kW/m² average, and dimensionally formed and finished in a copper casting with a shape suitable for service as a launder, a runner, a cooler, a wall cooler, a roof cooler, a burner block, a tuyere, a casting mold, an electrode clamp, a tap cooler, or a stave cooler in a pyrometallurgical furnace for the production of at least one of molten metal, metal alloy, matte, or slag, and comprising:
patterning a sand casting mold with a three dimensional pattern for a furnace cooler with a shape suitable for service as a launder, a runner, a cooler, a wall cooler, a roof cooler, a burner block, a tuyere, a casting mold, an electrode clamp, a tap cooler, or a stave cooler in a pyrometallurgical furnace for the production of at least one of molten metal, metal alloy, matte, or slag;
placing inside the sand casting mold a pipe coil comprising a UNS C70600 90%, C71300 75%, C71500 70%, C71640 66%, or UNS C70600 Schedule-40 water pipe or equivalent;
securing the pipe coil inside the sand casting mold with a mechanical device to prevent any movement during a subsequent molten copper pour of the pipe coils away from an optimum position determined from thermal and stress computer modelling of an end-of-campaign life state;
pouring into the mold and flooding around the pipe coil a liquefied molten high purity (99%-Wt) copper and de-oxidized during the casting process to produce a high-purity copper casting approximating UNS-type C11000;
cooling a resulting casting, removing it from the mold, and machining and otherwise finishing it and testing for its service as a cooler by an end user;
wherein, a resulting internal separation of the pipe coil at substantially every and all points of its outer surfaces to any cold face exceeds 5/16″ after the casting process is complete.

14. The method of claim 13, wherein the securing the pipe coil inside the sand casting mold with a mechanical device assumes an average heat flux on the hot face exceeding 25 kW/m² in the thermal and stress computer modelling of the end-of-campaign life state.

15. The method of claim 14, further comprising:
determining what is the optimal position of the pipe coils relative to any hot face of the cooler during the casting process comprises iterations of CFD and FEA computer modelling that assume particular rates of corrosion and/or wear, and include an adequate front copper cover at the end-of-campaign life state.

16. The method of claim 14, further comprising:
nesting together and distributing within a volume of the furnace cooler two or more independent and separate pipe coil circuits such there results in CFD and FEA computer modelling an even distribution of cooling efficiencies, and a twisting and intertwining inside in a way that each pipe coil circuit still fits with the other and within the furnace cooler, and that still evenly thermally services every zone inside;
wherein, any pressure drops measured in testing later between the two or more pipe coil circuits are verified to be nearly the same so the same flows of coolant will pass through when in service.
